(19) United States
(12) Patent Application Publication
(10) Pub. No.: US 2005/0181200 A1
(43) Pub. Date: Aug. 18, 2005

(54) Compacted absorbent polymers the production thereof and the use of the same

(76) Inventors: Richard Mertens, Krefeld (DE); Claudius Neumann, Rossdorf (DE)

Correspondence Address: SMITH MOORE LLP, P.O. BOX 21927, GREENSBORO, NC, 27420, US

(21) Appl. No.: 10/498,841

(22) PCT Filed: Dec. 16, 2002
(86) PCT No.: PCT/EP02/14362

(30) Foreign Application Priority Data
Dec. 14, 2001 (DE) 101 61 496.9

(51) Int. Cl. B27N 3/00

(52) U.S. Cl. 428/327; 264/109

(57) ABSTRACT

The present invention relates to compacted superabsorbers, producible in that a mixture, at least comprising synthetic particulate superabsorber, is subjected to a specific contact force or to a pressure, processes for producing such superabsorbers, composites produced from superabsorbers of this type and the use of such superabsorbers.

### CROSS-REFERENCE OF RELATED APPLICATIONS

This application is a national stage application under 35 U.S.C. § 371 of international application no. PCT/EP02/14362 filed Dec. 16, 2002, which is based on German Application no. 101 61 496.9, filed Dec. 14, 2001, and claims priority thereto. These applications are hereby incorporated herein in their entirety by this reference.

### FIELD OF THE INVENTION

The present invention relates to compacted superabsorbers, producible in that a mixture, at least comprising a synthetic particulate superabsorber, is subjected to a specific contact force or to a pressure, processes for producing such superabsorbers, composites produced from superabsorbers of this type, and the use of such superabsorbers.

### BACKGROUND OF THE INVENTION

So-called superabsorbers frequently find an application in many areas of technology or hygiene, if aqueous liquids should be absorbed and substantially bound in a solid phase, in order to prevent disadvantageous effects of the aqueous liquids in the respective environment. Particularly often, as a superabsorber, compounds are used which consist of synthetic polymers or respectively comprise such synthetic polymers.

Generally, superabsorbers, if they are substantially dry, are available as brittle salts. In practice, however, an array of problems arises therefrom. The permeability and thus the absorption properties of the superabsorber are influenced by, among other things, the particle size. In particular, small particles limit considerably the permeability of a superabsorber, since they swell very quickly on contact with water or aqueous solutions and can thereby block capillary structures of larger particles, and so, disadvantageously influence the absorption properties thereof.

In common applications of superabsorbers, the superabsorbers are, as a rule, ground to a particle size of about 150 to about 850 μm. However, because of the brittleness of the material in this procedure, a significant proportion of particles with a particle size of less than 150 μm arises. These particles must, however, be removed for the above-mentioned reasons before the use of the superabsorber. Generally, this occurs by means of sieving. The material separated in this way with a particle size of less than 250 μm can, however, only conditionally be recycled into the production process. As a result of this, in the past, in production of superabsorbers, fine dust fractions arose which had to be either stored at cost or disposed of.

In order to counter this problem in the past, many attempts were made to reconduct fine dust of this type into the production cycle. Thus, it is, for example, known from the state of the art, to recycle fine dust back into the polymerization process in order to build it back into larger polymer structures in the scope of the polymerization. If particles with a particle size of less than 250 μm are recycled into the polymerization process, they have the effect of a crosslinker. Thus, it is, however, disadvantageous that the crosslinking properties vary in different particle charges, so that in this way a defined end-product with defined properties is only obtainable with difficulty.

It is known from U.S. Pat. No. 5,002,986, to contact superabsorber particles in a mixing zone with an aqueous solution of an ionic crosslinker, in order to increase the absorption rate. The increase of the average particle size achieved according to the described process is, however, for practical purposes as a rule not sufficient and the conveying stability is unsatisfactory.

WO 99/30752 relates to compacted particles for hindering of odours in absorbent products. The compacted particles described in the named document are produced by compacting in the absence of a binding agent. These agglomerates decompose easily into the original fine dust on contact with water.

Problematic in the processes known from the state of the art is the fact that the obtained compact mats generally have insufficient abrasion stability or, as described in the last-named document, are not suitable for processing larger quantities of superabsorber particles with a particle size of less than 250 μm.

Furthermore, no indication can be taken from the processes known from the state of the art that the above-described fine dusts can be processed alone or together with larger particles into formed bodies, which have a satisfactory absorption behaviour and sufficient stability for their use, in particular in the area of hygiene.

### SUMMARY OF THE INVENTION

The present invention is related to compacted superabsorbers that have a satisfactory dimension stability and a simultaneously satisfactory abrasion behaviour for the range of uses, in particular in the area of hygiene. Further, the present invention is related to compacted superabsorbers that have a high proportion of primary particles having a particle size of less than about 250 μm and, despite this, show a satisfactory absorption behaviour for the application, in particular in the area of hygiene.

To that end, the present invention also is related to a process for producing compacted superabsorbers in which superabsorber particles with a particle size of less than about 250 μm could be used.

It was found that superabsorber particles with a particle size of less than about 250 μm, preferably less than about 200 μm, and particularly preferably less than about 150 μm, can be processed into compacts, in that they are, optionally in the presence of a binding agent, subjected to a specific contact force or to a pressure.

Thus, the invention is related to compacted superabsorber particles and processes for their production, as can be learned from the following text.

### DETAILED DESCRIPTION OF THE INVENTION

The subject matter of the present invention is, therefore, compacted superabsorbers, producible in that a mixture, at least comprising a synthetic particulate superabsorber, is subjected to a specific contact force of at least about 3 kN/cm or to a pressure of at least about 3 kN/cm², wherein more than about 5%, preferably more than about 20%, and particularly preferably more than about 35% of the particles used have a particle size of about 250 μm or less, preferably of about 200 μm or less and particularly preferably of about 150 μm or less. In a preferred embodiment of the superabsorber according to the invention more than about 35 wt.-% of the particles used have a particle size of less than about 150 μm.

A composition termed “compacted superabsorber” in the scope of the present invention comprises at least one superabsorber. Suitable superabsorbers, in the scope of the present invention, include, in principle, synthetic or at least partially synthetic materials that can absorb at least about 4 g/g, preferably at least about 10 g/g, and particularly preferably at least about 100 g/g of their own weight in water. In the scope of a preferred embodiment of the present invention, as absorbents are used in synthetic materials, in particular absorbent polymers.

An absorbent polymer suitable according to the invention comprises preferably at least one polymer based on at least one monoethylenically unsaturated monomer with one acidic group. The acidic groups of the monomers used can be partially or fully, preferably partially neutralised. In this context, reference is made to DE 195 29 348, the disclosure of which is hereby incorporated herein in its entirety by this reference and should be viewed as part of the disclosure of the present text.

Preferred monoethylenically unsaturated monomers with an acidic group are acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, sorbinic acid, α-chlorosorbinic acid, 2′-methylisocrotonic acid, cinnamic acid, p-chlorocinnamic acid, stearic acid, itaconic acid, citraconic acid, mesaconic acid, glutaconic acid, aconitic acid, maleic acid, fumaric acid, tricarboxyethylene and maleic acid anhydride, hydroxyl- or amino group-containing esters of the above acids, preferably of acrylic or methacrylic acid, such as, for example, 2-hydroxyethylacrylate, N,N-dimethylaminoethylacrylate, as well as the analogous derivatives of methacrylic acids, whereby acrylic acid as well as methacrylic acid are particularly preferred, and acrylic acid is even more preferred.

In addition to the monoethylenically unsaturated monomer with an acidic group, in the scope of the present invention, a suitable polymer also based on comonomers which are different to the monoethylenically unsaturated monomer with an acid group can be used in superabsorbers. As comonomer ethylenically unsaturated sulfonic acid monomers, ethylenically unsaturated phosphonic acid monomers and acrylamides are preferred.

Ethylenically unsaturated sulfonic acid monomers are preferably aliphatic or aromatic vinylsulfonic acids, or acrylic- or methacrylicsulfonic acids. As aliphatic or aromatic vinylsulfonic acids are preferred vinylsulfonic acid, allylsulfonic acid, 4-vinylbenzylsulfonic acid, vinyltoluenesulfonic acid and styrenesulfonic acid. Preferred acrylic- or methacrylicsulfonic acids include sulfoethylacrylate, sulfoethylmethacrylate, sulfopropylacrylate, sulfopropylmethacrylate, 2-hydroxy-3-methacryloxypropylsulfonic acid and 2-acrylamide-2-methylpropanesulfonic acid.

Further preferred are ethylenically unsaturated phosphonic acid monomers such as vinylphosphonic acid, allylphosphonic acid, vinylbenzylphosphonic acid, acrylamidoalkylphosphonic acids, acrylamidoalkyldiphosphonic acids, phosphonomethylated vinylamines, and (meth)acrylicphosponic acid derivatives.

Possible acrylamides are alkyl-substituted acrylamides or aminoalkyl-substituted derivatives of acrylamides or of methacrylamides such as N-vinylamide, N-vinyl formamide, N-vinylacetamide, N-vinyl-N-methylacetamide, N-vinyl-N-methylformamide, N-methylol(meth)acrylamide, vinyl pyrrolidone, N,N-dimethylpropylacrylamide, dimethylacrylamide or diethylacrylamide and the corresponding methacrylicamide derivatives, as well as acrylamide and methacrylamide, whereby acrylamide is preferred.

In quantities in the range of about 0.01 wt.-% to about 20 wt.-%, preferably from about 0.1 wt.-% to about 15 wt.-%, and particularly preferably from about 0.5 wt.-% to about 5 wt.-%, based on the total monomer used, a comonomer can be used also monomers with a low solubility in water. Examples of monomers of this type are acrylic acid esters and methacrylic acid esters such as ethylacrylate and ethylmethacrylate, butylacrylate and butylmethacrylate, vinylacetate, styrene or isobutylene or mixtures of two or more thereof.

Furthermore, water-soluble polymers in quantities in the range from about 0.01 wt.-% to about 20 wt.-%, preferably from about 0.1 wt.-% to about 15 wt.-%, and particularly preferably from about 0.5 wt.-% to about 5 wt.-%, based on the total monomer used, can be added to the monomer solution. Examples are polymers or copolymers of the above-described monomers such as polyacrylic acid, partially saponified polyvinyl acetate, polyvinyl alcohol, polyalkylene glycols, starches and starch derivatives, cellulose and cellulose derivatives, as well as other polysaccharides.

All described acids can be polymerised as free acids or as salts. A partial neutralisation is also possible. Furthermore, a full or partial neutralisation can occur also after the polymerisation. The neutralisation of the monomers can be carried out with alkali metal hydroxides, alkaline earth metal hydroxides, ammonia as well as carbonates or bicarbonates, or mixtures of two or more thereof. In addition, in principle, every further base which forms a water-soluble salt with the acid to be neutralised is suitable. A mixed neutralisation with different bases is also conceivable. Neutralisation with ammonia and alkaline metal hydroxides is preferred; particularly preferred are sodium hydroxide and ammonia.

In a preferred embodiment of the present invention, a superabsorber usable for compacting according to the invention has at least one of the following properties:
(a) maximum absorption of about 0.9 wt.-% aqueous NaCl-solution according to EDANA Recommended Test (ERT) 440.1-99 in a range from about 10 g/g to about 1000 g/g, preferably from about 15 g/g to about 500 g/g, and particularly preferably from about 20 g/g to about 300 g/g,
(b) the part extractable with about 0.9 wt.-% aqueous NaCl-solution according to ERT 470.1-99 amounts to less than about 30 wt.-%, preferably less than about 20 wt.-%, and particularly preferably less than about 10 wt.-%, based on the superabsorber,
(c) the swelling time to reach about 80% of the maximum absorption of about 0.9 wt.-% aqueous NaCl-solution according to ERT 440.1-99 lies in the range from about 0.01 min. to about 180 min., preferably from about 0.01 min. to about 150 min., and particularly preferably from about 0.01 min. to about 100 min.,
(d) the bulk density according to ERT 460.1-99 lies in the range from about 300 g/l to about 1000 g/l, preferably about 310 g/l to about 800 g/l, and particularly preferably about 320 g/l to about 700 g/l,
(e) the pH-value according to ERT 400.1-99 of about 1 g of superabsorber in about 1 l water lies in the range from about 4 to 10, preferably from about 5 to about 9, and particularly preferably from about 5.5 to about 7.5, as well as
(f) CRC according to ERT 441.1-99 in the range from about 10 g/g to about 100 g/g, preferably about 15 g/g to about 80 g/g, and particularly preferably about 20 g/g to about 60 g/g.

The property combinations of two or more of these properties arising from the above properties represent preferred respective embodiments of the superabsorber according to the invention. Furthermore, as embodiments according to the invention are particularly preferred superabsorbers with the following properties or property combinations depicted with letters or letter combinations: a, b, c, d, e, f, ab, abc, abcd, abcde, abcdef, bc, bcd, bcde, bcdef, cd, cde, cdef, de, def, ef, whereby a, b, c, f, ab, and abf are particularly preferred.

A superabsorber underlying the present invention can be produced from the above-mentioned monomers by means of different polymerisation methods. For example, in this context are cited bulk polymerisation, solution polymerisation, spray polymerisation, inverse emulsion polymerisation, and inverse suspension polymerisation. Preferably the solution polymerisation is carried out in water as solvent. The solution polymerisation can occur continuously or discontinuously. From the state of the art is known a broad spectrum of variants with respect to reaction proportions such as temperatures, type, and quantity of the initiators, as well as the reaction solution. Typical processes are described in the following patent documents: U.S. Pat. No. 4,286,082, DE 27 06 135, U.S. Pat. No. 4,076,663, DE 35 03 458, DE 40 20 780, DE 42 44 548, DE 43 23 001, DE 43 33 056, and DE 44 18 818.

The cited documents are hereby incorporated herein in their entirety by this reference, whereby the corresponding parts of the cited documents which relate to polymerisation processes are considered as part of the disclosure of the present text.

A superabsorber that can be used in the scope of the present invention for compacting can, for example, be crosslinked by means of a chemical crosslinker or by thermal crosslinking, or radiation crosslinking or by two or more of the cited processes, whereby crosslinking using a chemical crosslinker is preferred.

Chemical crosslinking is achieved with all crosslinkers generally known to the skilled person. Crosslinkers of this type are preferably used in a quantity of less than 7 wt.-%, preferably about 0.1 wt.-% to about 5 wt.-%, based on the total weight of the monomer used. Preferred crosslinkers according to the invention are polyacrylic or polymethacrylic acid esters, which are obtained for example by conversion of a polyol or an ethoxylated polyol such as ethylene glycol, propylene glycol, trimethylol propane, 1,6-hexanediol, glycerine, pentaerythritol, polyethylene glycol or polypropylene glycol with acrylic acid or methacrylic acid.

A crosslinker can also include polyols, amino alcohols as well as mono(meth)acrylic acid esters and monoallylethers thereof. Further suited as crosslinkers are also acrylic acid esters of monoallyl compounds of polyols and amino alcohols. In this context, reference is made to DE 195 43 366 and DE 195 43 368. The disclosure of the cited documents is hereby incorporated herein in its entirety by this reference and is thus considered as part of the disclosure of the present text.

As suitable crosslinkers are considered for example: 1,4-butanediol diacrylate, 1,4-butanediol dimethacrylate, 1,3-butyleneglycol diacrylate, 1,3-butyleneglycol dimethacrylate, diethyleneglycol diacrylate, diethyleneglycol dimethacrylate, ethoxylated bisphenol-A-diacrylate, ethoxylated bisphenol-A-dimethacrylate, 1,6-hexanediol diacrylate, 1,6-hexanediol methacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol dimethacrylate, dipentaerythritol pentaacrylate, pentaerythitol tetraacrylate, pentaerythritol triacrylate, trimethylolpropane triacrylate, trimethylol trimethacrylate, tris(2-hydroxyethyl)isocyanurate triacrylate, tris(2-hydroxy)isocyanurate trimethacrylate, divinyl esters of polycarboxylic acids, diallyl esters of polycarboxylic acids, triallylterephthalate, diallylmaleate, diallylfumarate, hexamethylene bismaleic amide, trivinyl trimellithate, divinyl adipate, diallylsuccinate, ethylene glycol divinylether, cyclopentadiene diacrylate, triallylamine, tetraallylammonium halide, divinylbenzene, divinylethers, N,N′-methylene bisacrylamide, N,N′-methylene bismethacrylamide and ethylene glycol dimethacrylate. Preferred crosslinkers among these are N,N′-methylene bisacrylamide, N,N′-methylene bismethacrylamide, polyethylene glycol diacrylate, polyethylene glycol dimethacrylate or triallylamine or mixtures of two or more of the cited compounds.

Superabsorbers which can be used according to the invention can, for example, also be post-crosslinked. Suitable “post-crosslinkers” include organic carbonates, polyquatemary amines, polyvalent metal compounds, and compounds which have at least two functional groups which can react with carboxyl groups of the untreated superabsorber. These are, in particular, polyols and amino alcohols such as ethylene glycol, diethylene glycol, triethylene glycol, tetraethylene glycol, polyethylene glycol, glycerine, polyglycerine, propylene glycol, ethanolamine, diethanolamine, triethanolamine, propanolamine, polyoxypropylene, oxyethyleneoxypropylene-blockpolymers, sorbitan fatty acid esters, polyoxyethylene sorbitan fatty acid esters, trimethylolpropane, pentaerythritol, polyvinyl alcohol and sorbitol, polyglycidylether compounds, such as ethylene glycol diglycidylether, polyethyleneglycol diglycidylether, glycerine diglycidylether, glycerolpolyglycidylether, pentaerythritolpolyglycidylether, propylene glycol diglycidylether and polypropylene glycol diglycidylether, polyaziridine compounds, such as 2,2-bishydroxymethylbutanol-tris[3-(1-aziridinyl)propionate], 1,6-hexamethylene diethylene urea and diphenylmethane-bis-4,4′-N,N′-diethylene urea, haloepoxy compounds such as ethylene diamine, diethylene triamine, triethylene tetraamine, tetraethylene pentaamine, pentaethylene hexaamine and polyethylene imines, polyisocyanates such as 2,4-toluylene-diisocyanate and hexamethylene diisocyanate, zinc hydroxides, potassium, aluminium, iron, titanium and zirconium halides, alkylene carbonates such as 1,3-dioxalane-2-one and 4-methyl-1,3-dioxalane-2-one, polyvalent metal compounds such as salts, poly quaternary amines such as condensation products of dimethyl amines and epichlorohydrin, homo- and copolymers of diallyldimethyl ammonium chloride, and homo- and copolymers of diethylamino(meth)acrylate methylchloride ammonium salts. Among these compounds are preferred diethylene glycol, triethylene glycol, polyethylene glycol, glycerine, polyglycerine, propyleneglycol, diethanolamine, triethanolamine, polyoxypropylene, oxyethylene oxypropylene block copolymer, sorbitan fatty acid ester, polyoxyethylene sorbitan fatty acid ester, trimethylolpropane, pentaerythritol, polyvinyl alcohol, sorbitol, alkylene carbonates such as 1,3-dioxolane-2-one, 1,3-dioxolane-2-one, 4-methyl-1,3-dioxolane-2-one, 4,5-dimethyl-1,3-dioxolane-2-one, 4,4-dimethyl-1,3-dioxolane-2-one, 4-ethyl-1,3-dioxolane-2-one, 4-hydroxymethyl-1,3-dioxolane-2-one, 1,3-dioxane-2-one, 4-methyl-1,3-dioxane-2-one, 4,6-dimethyl-1,3-dioxane-2-one, 1,3-dioxolane-2-one, poly-1,3-dioxolane-2-one and ethylene glycol diglycidylether, polyoxazolines such as 1,2-ethylene bisoxazoline, crosslinkers with silane groups such as γ-glycidoxypropyltrimethoxy silane and γ-aminopropyltrimethoxy silane, oxazolidinones such as 2-oxazolidinone, bis- and poly-2-oxazolidinones, as well as diglycol silicates.

From the above-cited post-crosslinkers, ethylene carbonate is particularly preferred.

These compounds are preferably used in a quantity in the range from about 0.01 wt.-% to about 30 wt.-%, preferably about 0.1 wt.-% to about 20 wt.-%, and particularly preferably about 0.5 wt.-% to about 10 wt.-%, based on the untreated superabsorber. Organic solvent can be added to the mixture in a quantity of about 0 wt.-% to about 60 wt.-%, preferably about 0.1 wt.-% to about 40 wt.-%, and particularly preferably about 0.2 wt.-% to about 50 wt.-%, based on the untreated polymer (Pu). Preferred organic solvents include lower alcohols such as methanol, ethanol, n-propanol, isopropanol, n-butanol, isobutanol, sec-butanol and t-butanol, ketones such as acetone, methylethyl ketone and methylisobutyl ketone, ethers such as dioxane, tetrahydrofuran and diethylether, amides such as N,N-dimethylformamide and N,N-diethyl formamide as well as sulfoxides such as dimethylsulfoxide.

In the scope of the present invention, superabsorbers can moreover be used which have an outer portion surrounding an inner portion, whereby the outer portion has a higher degree of crosslinking than the inner portion. It is in this context further preferred that the inner portion has a larger diameter than the outer portion. If, in the scope of the present invention, a so-called post-crosslinked superabsorber of this type is used, it has preferably at least one of the following properties:
(A) maximum absorption of about 0.9 wt.-% aqueous NaCl-solution according to ERT 440.1-99 in a range from about 10 g/g to about 800 g/g, preferably from about 15 g/g to about 400 g/g, and particularly preferably from about 20 g/g to about 200 g/g,
(B) the part which is extractable with about 0.9 wt.-% aqueous NaCl-solution according to ERT 470.1-99 amounts to less than about 30 wt.-%, preferably less than about 20 wt.-%, and particularly preferably less than about 10 wt.-%, based on the post-crosslinked superabsorber,
(C) the swelling time to reach about 80% of the maximum absorption of about 0.9 wt.-% aqueous NaCl-solution according to ERT 440.1-99 lies in the range from about 0.01 min. to about 180 min., preferably from about 0.01 min. to about 150 min., and particularly preferably from about 0.01 min. to about 100 min.,
(D) the bulk density according to ERT 460.1-99 lies in the range from about 300 g/l to about 1000 g/l, preferably about 310 g/l to about 800 g/l, and particularly preferably 320 g/l to 700 g/l,
(E) the pH-value according to ERT 400.1-99 of about 1 g of the post-crosslinked superabsorber in about 1 l water lies in the range from about 4 to about 10, preferably from about 5 to about 9, and particularly preferably from about 5.5 to about 7.5,
(F) CRC according to ERT 441.1-99 in the range from about 10 g/g to about 100 g/g, preferably about 15 g/g to about 80 g/g, and particularly preferably about 20 g/g to about 60 g/g.

The property combinations of two or more of these properties which arise from the above properties represent respectively preferred embodiments of the process according to the invention. Further particularly preferred as embodiments according to the invention are post-crosslinked superabsorbers with the following properties or property combinations depicted as letters or letter combinations: A, B, C, D, E, F, AB, ABC, ABCD, ABCDE, ABCDEF, BC, BCD, BCDE, BCDEF, CD, CDE, CDEF, DE, DEF, and/or EF.

Besides the cited polymers a composition described as “compacted superabsorber” according to the invention can comprise further additives.

Suitable additives include, for example, non-water-soluble inorganic solids. Particularly suited are thus water-insoluble inorganic solids, which have a particle size in a range from about 0.001 μm to about 1000 μm, in particular about 50 μm to about 500 μm. In the scope of a preferred embodiment of the present invention, a compacted superabsorber according to the invention comprises a water-insoluble inorganic solid or a mixture of two or more water-insoluble inorganic solids, whereby the particle size of the solid particles lies within a range of about 80 μm to about 400 μm, wherein preferably at least about 5%, for example, at least about 10, 20, 50 or at least about 80% of the solid particles have a particle size of less than about 200 μm, in particular less than about 150 μm. Particularly suitable particle sizes lie for example in a range from 5 nm to about 100 μm.

Suitable water-insoluble inorganic solids include, for example, titanium dioxide, clay minerals such as bentonite, kaolin, or attapulgite, zeolites, pyrogenic silicic acids, and the like.

In the scope of a preferred embodiment of the present invention, additives include non-water-soluble inroganic solids, which have at least one of the following properties:
(α) a surface according to BET according to DIN 66131 of at least 10, preferably of at least about 50 m²/g, and particularly preferably of at least about 200 m²/g, and even more preferably in the range from about 180 m²/g to about 1000 m²/g,
(β) a pH-value in a about 4% aqueous dispersion in the range from about 2 to about 11, preferably from about 2.5 to about 8, and particularly preferably from about 3 to about 5,
(γ) a tumped density according to DIN 787/XI and JIS K 5101/18 (not sieved):

less than about 800 g/l, preferably less than about 300 g/l, and preferably less than about 60 g/l.

The property combinations of two or more of these properties arising from the above properties represent respectively preferred embodiments. Further particularly preferred as embodiments according to the invention are compacted superabsorbers, in which the inorganic solid or a mixture of two or more inorganic solids as the following properties or property combinations depicted as letters or letter combinations: α, β, γ, αβ, αβγ, βγ or αγ, whereby αβγ is particularly preferred. It is further preferred in the process according to the invention that the inorganic solid is based on a silicon compound, whereby all silicon oxygen compounds known for the process, for example, aerosils and kaolins, are preferred, among which aerosils are particularly preferred.

It is further preferred that a compacted superabsorber according to the invention comprises the inorganic solid or a mixture of two or more inorganic solids in a quantity of about 0.001 wt.-% to about 40 wt.-%, preferably from about 0.01 wt.-% to about 20 wt.-%, and particularly preferably from about 0.05 wt.-% to about 5 wt.-%.

In the scope of a further preferred embodiment of the present invention a compacted superabsorber according to the invention comprises at least one inorganic binding agent or one organic binding agent. It is, in the scope of the present invention, likewise possible and provided, that a superabsorber according to the invention comprises a mixture of two or more inorganic or a mixture of two or more organic binding agents, or a mixtures of one or more inorganic binding agents and one or more organic binding agents.

As inorganic binding agents, in the scope of the present invention, are suited water-soluble compounds, which form, in aqueous solution, an ionized metal cation, an aminocation or an iminocation, whose valence amounts to at least about 2.

Particularly preferred are thus metal cations, such as can be obtained from metals of the groups IIA-VIA, IB, IIB, and VII of the periodic table of the elements. Suitable are the salts, oxides, hydroxides, or comparable compounds of metals of this type, provided that the corresponding compound is water-soluble, the compound ionizes or dissociates in water, and the metal cation, the amine, or imine has a valence of at least about 2. Examples of suitable metal cations whose valence amounts to at least about 2 are aluminium, copper, zinc, zirconium, iron, cobalt, chromium, or titanium, or mixtures of two or more thereof. In the scope of the present invention, aluminium is preferred as metal cation. Suitable inorganic binding agents are, for example, aluminium sulfate, aluminium sodium sulfate, polyaluminium chloride, aluminium diacetate, basic aluminium hydroxide (whereby the mol ratio of aluminium hydroxide and sodium hydroxide is about 1:1), cobalt acetate, copper sulfate, zinc acetate, zirconium acetate, zirconium tetrachloride, or zirconium nitrate, or mixtures of two or more of the cited compounds. In the scope of a further preferred embodiment of the present invention, a compacted superabsorber according to the invention comprises, as inorganic binding agent, an aluminium salt, in particular aluminium sulfate.

In the scope of a further preferred embodiment of the present invention a compacted superabsorber according to the invention can comprise, besides or instead of an inorganic binding agent, an organic binding agent. Suitable organic binding agents in the scope of the present invention include, in principle, all binding agents which make available at least one polyvalent amine or imine. Thus, suitable in the scope of the present invention are organic binding agents which have a molecular weight of up to about 200. It is, however, likewise provided according to the invention to use as a component of the compacted superabsorber according to the invention organic binding agents which have a molecular weight lying significantly thereabove, for example, up to about 5,000,000, in particular about 1000 to about 1,000,000.

Suitable organic binding agents are, for example, polyamines, polyimines, polyamides, chitosan, or polyvinylpyrrolidone.

The proportion of inorganic or organic binding agent or a mixture of two or more binding agents of this type in the compacted superabsorber amounts, in the scope of the present invention, to up to about 30 wt.-%, for example, about 0.1 wt.-% to about 15 wt.-% or about 0.5 wt.-% to about 5 wt.-%.

In the scope of a further preferred embodiment of the present invention, a compacted superabsorber according to the invention comprises water. The water content of a compacted superabsorber according to the invention amounts, for example, to up to about 30 wt.-%, preferably however about 0.1 wt.-% to about 15 wt.-% or about 0.5 wt.-% to about 10 wt.-%. Particularly suited water contents lie, for example, in a range from about 0.8 to about 5 wt.-%.

In the scope of a further embodiment of the present invention, a compacted superabsorber according to the invention comprises at least one further organic polymer (Ps) that does not fall under the above definition of a superabsorber or of a binding agent.

It is preferred according to the invention if a further polymer (Ps) of this type as an about 4 wt.-% solution in deionized water has a viscosity at 20° C. in the range of about 1 to about 100,000, preferably from about 10 to about 50,000, and particularly preferably from about 100 to about 10,000 mPa.s.

Preferably, the polymer (Ps) is a polymer based on polyvinyl alcohol, polyethylene glycol, polyglycerine, gelatine, or saccharides. As examples are here cited: xanthane, starches, guar seed flour, alginate, dextrin, agar-agar, carragen, tragacanth, gum arabic, alginates, pectins, polyose, guar flour, carob seed flour, vinylpolymers, polycarboxylic acids, and polyethers. A compacted superabsorber according to the invention can comprise the polymers mentioned respectively individually or as a mixture of two or more thereof.

According to a preferred embodiment of the present invention, the polymer (Ps) is based on a saccharide. Particularly preferred are derivatized saccharides, such as esters, ethers, and carboxymethylated derivatives. The ethers of the saccharides are preferably saccharides derivatized with C₁- to C₁₀₀₀₀₀-, preferably C₁- to C₁₀₀₀₀- and even more preferably with C₁- to C₁₀-alkyl groups. Among these, in turn, are preferred methyl, ethyl, propyl, and butyl derivatized saccharides, whereby the methyl group derivatized saccharides are particularly preferred. Examples of esters of the saccharides are acetates, acetobutyrates, acetopropionates, or propionates. The polymer (Ps) comprises preferably at least about 10 wt.-%, preferably at least about 50 wt.-%, and particularly preferably at least about 90 wt.-%, based on the polymer (Ps), a saccharide, or a polysaccharide. Among the polysaccharides, celluloses and starches are preferred, whereby cellulose is particularly preferred. It is further preferred that the celluloses are present as carboxymethylcelluloses, whereby sodium and potassium carboxymethylcelluloses are preferred, and sodium carboxymethylcellulose is particularly preferred.

A compacted superabsorber according to the invention comprises, in the scope of a preferred embodiment of the present invention, the further organic polymer or a mixture of two or more further organic polymers in a quantity of up to about 30 wt.-%, for example, about 0.1 wt.-% to about 15 wt.-%, or preferably about 0.5 wt.-% to about 5 wt.-%.

The compacted superabsorbers according to the invention are, in the scope of the present invention, obtainable by means of a process in which at least one superabsorber, optionally in a mixture with one or more of the further, above-mentioned, components, is subjected to a specific contact force of at least about 3 kN/cm or to a pressure of at least about 3 kN/cm².

In the scope of the compacting carried out in the production of the compacted superabsorber according to the invention, a superabsorber or a mixture of two or more superabsorbers, or a mixture of one or more superabsorbers and water or a binding agent, or water and of a binding agent, as well as optionally of one or more of the above-mentioned additives is subjected to a pressure, which lies within the above-mentioned range. It is insignificant in the scope of the present invention in what way this pressure is exerted. Preferably, in the scope of the present invention, however, an agglomeration by means of stamping or rolling is preferred. Particularly preferred in the scope of the present invention is roll compacting.

In the roll compacting, one of the above-cited compositions is compacted by means of pressing between two rollers which are turning in respectively opposing rotation directions. It is, in the scope of the present invention, possible and provided, that smooth or profiled rollers are used in the compacting. Suitable processes for roll compacting are known to the skilled person. Suited are, for example, processes for compacting, briquetting, tabletting, or granulating, such as can be carried out commonly using correspondingly profiled rollers.

The compositions comprising superabsorber and provided for compacting can in principle be compacted in the present form. It is, however, preferred in the scope of the present invention, if the composition provided for compacting is subjected to a pre-compression before the compacting step. The pre-compression is preferably carried out in a screw compressor (compression snail).

In the scope of a preferred embodiment of the present invention, a composition provided for compression comprises water or a binding agent or water and a binding agent.

For as homogeneous a mixing as possible of superabsorber and water or superabsorber and binding agent or a mixture of superabsorber, water, and binding agent, in the scope of a preferred embodiment of the present invention, the superabsorber or the mixture of two or more superabsorbers is mixed with water or binding agent or mixtures thereof in the scope of the pre-compression. To this end, for example, the superabsorber or the mixture of two or more superabsorbers is introduced into a screw conveyer and then, at a downstream position, water or binding agent or mixtures thereof is introduced thereto. If a composition provided for compacting comprises further additives, these are preferably likewise in the precompression, mixed with the superabsorber or with a mixture of two or more superabsorbers. It is, however, in the scope of the present invention, likewise provided that the mixing of the components of the composition provided for compacting is carried out not in the pre-compressing, but rather in a separate step. All mixing devices known to the skilled person can be used for mixing in this case. If a composition provided for compacting comprises water and a binding agent, the order of addition of water and binding agent to the superabsorber or to the mixture of two or more superabsorbers is in principle arbitrary. Thus, for example, the water can first be added and then the binding agent, or first the binding agent and then the water. It is, in the scope of the present invention, however, likewise provided that an addition of water and binding agent occurs at the same time, in particular as a solution of the binding agent or of the mixture of two or more binding agents in water.

If a composition provided for compacting comprises a binding agent and further additives, the order of addition of binding agent and additives to the superabsorber or to the mixture of two or more superabsorbers is in principle arbitrary. It is, in the scope of the present invention, however, preferred, if the addition of additives occurs after the addition of binding agent or binding agents to the superabsorber, or to the mixture of two or more superabsorbers.

The compacting occurs, in the scope of the present invention, at a temperature of about 0° C. to about 100° C. Preferably, the compacting occurs in a temperature range from about 20° C. to about 80° C. The necessary temperature can thus, for example, be achieved by means of external cooling or heating of the compacting unit. Thus, for example, in a roll compacting, one roller or both rollers can be cooled or heated. It is, in the scope of the present invention, however, likewise provided that a compacting unit is operated substantially without external temperature influence. In this context, a temperature increase of the material during the compacting can be observed, for example, in a dependence on the composition used for compacting and the form of the pressure exerted in the scope of the compacting. The temperature prevailing during the compacting should in each case be selected so that the compacted superabsorber according to the invention shows no loss of absorption power caused by caking.

The pressure prevailing during the compacting, or respectively, the force exerted on the composition provided for compacting is, in the scope of the present invention, selected so that at least a pressure of about 3 kN/cm² or a specific contact force of at least about 3 kN/cm is exerted on the composition provided for compacting. By “specific contact force” is understood, in the scope of the present text, a force per cm roller width present between two rollers.

Preferably, the compacting in the scope of the present invention is achieved by means of rollers. Thus, preferably a specific contact force of at least about 10 kN/cm, particularly preferably at least about 40 kN/cm, and even more preferred at least about 100 kN/cm prevails, whereby preferably the specific contact force does not exceed a value of about 1000 kN/cm.

The compacted superabsorbers according to the invention are, in the scope of the present invention, either further processed in the present form, or dried, after the compacting step. Provided that the composition used for compacting comprises water, the drying can be carried out either at reduced pressure or at ambient pressure, the temperature amounts to preferably about 30 to about 180, for example, about 50 to about 90° C. The duration of drying amounts, depending on the water content of the compacted superabsorber, to about 5 minutes to about 5 hours.

The compacted superabsorbers according to the invention are obtained in the scope of the compacting, depending on the selection of the process used for compacting, as flakes, granulates, pastilles, tablets, or similar formed bodies, such as can be produced by a suitable selection of the compacting process.

It is provided in the scope of the present invention that the compacted superabsorbers can be further used as formed bodies, such as are obtained directly from the compacting and the optional subsequent drying.

Formed bodies which can be produced in the scope of the present invention can in principle have any substantially irregular or regular spacial form. Suitable regular spacial forms are for example spheres, ellipsoids, cylinders, cubes, or cuboids.

It is, in the scope of the present invention, however, likewise possible and provided that the compacted superabsorbers are subjected to a grinding after the compacting step and optionally a subsequent drying step, whereby a grinding of this type preferably leads to particle sizes in the range of about 100 μm to about 1000 μm, preferably from about 150 μm to about 1000 μm, and particularly preferably from about 150 μm to about 850 μm. Preferably a particle size distribution is achieved, which has a weight average particle size in the range from about 400 μm to about 700 μm with not more than about 16 wt.-% of these particles with a particle size of less than about 200 μm and not more than about 16 wt.-% of these particles have a particle size of not more than about 1200 μm. It has proved particularly useful to achieve the particle size distribution by sieving.

In the scope of a further preferred embodiment of the present invention, the compacted superabsorbers can be provided with a coating of a water soluble polymer. Such coated compacted superabsorbers have the advantage that they generate less abrasion on transport, have a lower sensitivity to air humidity, and, despite this, quickly show their absorptive effect in an aqueous medium. Further, in the processing of compacted superabsorbers, less dust forms in comparison to noncompacted superabsorbers.

Suitable water-soluble polymers coming into question for a coating of this type, in the scope of the present invention include, in principle, all polymers which have a water solubility of at least about 1 g/l. Polymers of this type preferably have one or more acidic groups at the polymer backbone. Particularly suited in the scope of the present invention are polymers which have a carboxylic acid or a sulfonic acid group or both; particularly preferred are polymers which have carboxylic acid groups at the polymer backbone. For producing the polymers which are suited as coatings according to the invention, the monomers already cited above in the scope of the present text are, for example, suitable.

In the scope of a preferred embodiment of the present invention, water-soluble polymers include polymers of acrylic acid or methacrylic acid or copolymers of acrylic acid and methacrylic acid. Suitable polymers according to the invention can comprise, besides the component acrylic acid or methacrylic acid or both components, yet further monomer building blocks, which must not necessarily have an acidic group. Suitable comonomers of this type are, for example, acrylic acid esters or methacrylic acid esters or carboxylic acid vinyl esters, acrylonitrile, styrene, isoprene, and butadiene, in particular, vinyl acetate.

In the scope of a particularly preferred embodiment of the present invention, the absorbent agents used according to the invention are coated with a polymer layer which comprises at least one of the two which are known under the trade names EUDRAGIT® L100 or EUDRAGIT® S100 (producer: Röhm GmbH, Darmstadt, Germany). These polymers are anionic polymers based on methacrylic acid and methacrylic acid esters. The ratio of carboxylic groups to ester building blocks amounts, in the EUDRAGIT® L-types to about 1:1, in the EUDRAGIT® S-types about 1:2.

The cited polymers are applied to the absorbent agents usable in the scope of the present invention either as a solution in organic solvents (alcohols, acetone), as mixtures of organic solvents with water or as pure aqueous latex dispersions.

In respect of the properties of the polymers preferably used for producing a polymer coating of this type and their application, reference is explicitly made to the publications “EUDRAGIT-Magensaftresistente Überzüge (Basis-Info 1)” of the company Röhm GmbH as well as K. Lehmann and H. U. Petereit, Filmüberzüge auf Basis wässriger Polymethacrylat-Dispersionen mit verzögertem Zerfall im Darmbereich, Pharm. Ind, 55, 6, 615-618 (1993), K. O. R. Lehmann, Aqueous Polymeric Coatings for Pharmaceutical Dosage Forms, Chapter 4, Chemistry and Application Properties of Polymethacrylate Coating Systems, Edited by James W. McGinity, Marcel Dekker, Inc., New York, 1989, K. Lehmann, Microcapsules and Pharmacy, Chapter 4, Fluid-Bed Spray Coating, Edited by Max Donbrow, CRC Press, Inc, Boca Raton, 1992, whose disclosure is hereby incorporated herein in its entirety by this reference and considered as subject matter of the disclosure of the present text.

In addition, the invention relates to compacted superabsorbers with at least one of the following properties:
(β1) CRC (Centrifugation Retention Capacity) of at least about 10 g/g, preferably of at least about 15 g/g, and particularly of at least about 20 g/g, even more preferably at least about 25 g/g,
(β2) an AAP (Absorbency Against Pressure) with a load of about 0.3 psi and of at least about 15 g/g, preferably at least about 20 g/g,
(β3) an AAP with a load of about 0.9 psi and of at least about 8 g/g, preferably at least about 12 g/g,
(β4) swell pressure of at least about 100 g, preferably of at least about 500 g, more preferably of at least about 600 g, and even more preferably about 800 g.

The property combinations of two or more of these properties arising from the above properties represent respectively preferred embodiments of the compacted superabsorber according to the invention. Furthermore, as particularly preferred embodiments according to the invention, include processes in which the compacted superabsorber has the properties or property combinations depicted in the following as letters or combinations of letters: β1, β2, β3, β4, β1β2, β1β2β3, β1β2β3β4, β2β3, β2β3β4, and β3β4, whereby β1, β2, β3, β1β2, and β1β2β3 are particularly preferred.

An embodiment according to the invention forms a compacted superabsorber with:
CRC of at least about 15 g/g,
AAP with about 0.3 psi load of at least about 15 g/g,
AAP with about 0.9 psi of at least about 8 g/g, and
particle size distribution in the range from about 150 μm to about 850 μm.

The present invention also relates to a process for producing compacted superabsorbers, in which a composition, at least comprising synthetic particulate superabsorber, is compacted in that the composition is subject to a specific contact force of at least about 3 kN/cm or to a pressure of at least about 3 kN/cm², whereby more than about 5%, preferably more than about 20%, and particularly preferably more than about 35% of the particles used have a particle size of about 250 μm or less, preferably of about 200 μm or less and particularly preferably of about 150 μm or less.

In a further preferred embodiment of the process according to the invention, compositions are thus used for compacting, which comprise at least one superabsorber and at least water. In this context, it is preferred that the particles are mixed, before compacting, with at least about 1 wt.-%, preferably with at least about 2 wt.-%, and even more preferably with at least about 4 wt.-% water, based on the weight of the total particles used in compacting.

In the scope of a further preferred embodiment of the present invention, compositions are used in compacting, which comprise, in addition to at least one superabsorber, at least one inorganic or at least one organic binding agent. In the scope of a further preferred embodiment of the present invention, in the compacting, compositions are used which comprise at least one superabsorber, water, and at least one inorganic or organic binding agent or mixtures thereof.

Suitable inorganic or organic binding agents have already been described above in the scope of the present text.

In the scope of a further preferred embodiment of the present invention, a composition provided for compacting comprises water and an inorganic binding agent.

Preferably, the water content of a composition provided for compacting amounts to at least about 0.1 wt.-%; preferably, however, the water content lies above, for example, at least about 1 wt.-%, about 2 wt.-%, about 4 wt.-%, about 8 wt.-%, or about 20 wt.-%.

According to a further preferred embodiment of the present invention, in the scope of the process according to the invention, a superabsorber or a mixture of two or more superabsorbers is combined with and mixed with an aqueous solution of an inorganic binding agent or organic binding agents, preferably with an aqueous solution of an inorganic binding agent before the compacting. The mixing can, in principle, as already stated above, occur in any way. It is, however, preferred according to the invention if the mixing of superabsorber or superabsorbers and the aqueous solution of a binding agent occurs in the scope of a precompression before the actual compacting step.

The addition of the corresponding binding agent occurs preferably by means of aqueous solutions of the corresponding binding agent, whereby suitable aqueous solutions have a concentration of about 1 to about 99 wt.-%, for example about 5 to about 60 wt.-%. In the use of organic binding agents, a higher or a lower concentration can optionally be required, depending on the solubility of the binding agent in water and depending on the viscosity of an aqueous solution of this type.

If, as a binding agent is used, for example, an inorganic salt of a polyvalent metal cation, as described above, the concentration of an aqueous solution comprising a salt of this type amounts preferably to about 20 to about 70 wt.-%, in particular about 40 to about 60 wt.-%.

In the scope of a preferred embodiment of the present invention, in processes according to the invention, an aqueous solution of Al₂(SO₄)₃.18 H₂O is used as a binding agent, whereby the concentration of Al₂(SO₄)₃.18 H₂O in the solution amounts to about 50 wt.-%.

The organic or inorganic binding agents are added to the composition provided for compacting in a quantity such that the concentration of the organic or inorganic binding agent, or the concentration of a mixture of two or more such binding agents, based on the fraction of superabsorber or superabsorbers, amounts to about 0.1 to about 20 wt.-%, in particular about 0.5 to about 10 wt.-%.

In the course of a preferred embodiment of the process according to the invention, the superabsorber particles are mixed, before the compacting, with at least about 1 wt.-% water, based on the weight of the total particles used for compacting.

Particularly suited for carrying out the process according to the invention are roll compactors, double roller compactors, ring-roll presses, or stamp presses such as ram extruders, screw presses, or extersche extrusion presses (Extersche Strang-press).

According to a further embodiment according to the invention of the process according to the invention, as well as the compacted superabsorber according to the invention, it is preferred that the values, only given with a lower limit, of features according to the invention have an upper limit which is about 20 times, preferably about 10 times, and particularly preferably about 5 times the most preferred value of the lower limit.

The compacted superabsorbers according to the invention can in principle be conducted in any form to a further use. Thus it is, for example, possible, to use the compacted superabsorbers according to the invention or mixtures with further substances in common applications such as hygiene articles or technical applications such as cables or sealings. It is, in the scope of the present invention, however, likewise possible to use the compacted superabsorbers according to the invention together with further superabsorbers which have not been produced according to a process according to the invention or which do not correspond to the compacted superabsorbers according to the invention, in the scope of a technical application.

In the scope of a preferred embodiment of the present invention, the compacted superabsorbers according to the invention are used together with non-compacted superabsorbers. As non-compacted superabsorbers are suited in principle, all compounds are understood commonly under the term “superabsorber”. In the scope of a preferred embodiment, however, the compacted superabsorbers according to the invention are used together with non-compacted superabsorbers which have a similar or identical composition to the compacted superabsorbers according to the invention.

In the scope of a further preferred embodiment of the present invention, in the production of the superabsorbers according to the invention, particles are used with a particle size of less than about 150 μm, as are formed in the production of non-compacted superabsorbers, whereby the compacted fine parts according to the invention are then used together with the non-compacted superabsorbers, in the production of which the fine parts are formed, in a mixture. The fraction of compacted superabsorber according to the invention in such a mixture amounts to about 0.5 wt.-% to about 99 wt.-%, in particular about 1 wt.-% to about 20 wt.-%.

Likewise, the subject matter of the present invention is a process for producing a composite, in which a compacted superabsorber according to the invention or a compacted superabsorber produced according to a process according to the invention is brought into contact with a substrate.

The present invention also relates even more to a composite obtainable according to the process described in the previous paragraph.

According to the invention, under the term “composite” are understood absorbent cores, sealant materials, cables, as well as diapers and further hygiene articles—sanitary napkins or incontinence products—comprising absorbent cores.

If the composite is an absorbent core, a compacted superabsorber according to the invention is worked into a substrate. Predominantly suitable materials for a core considered as a substrate comprise cellulose, preferably fibers. In an embodiment of the core, an absorbent superabsorber according to the invention is worked in a quantity in the range from about 10 wt.-% to about 90 wt.-%, preferably from about 20 wt.-% to about 80 wt.-%, and particularly preferably from about 40 wt.-% to about 70 wt.-%, based on the core. In an embodiment of the core, a compacted superabsorber according to the invention is worked in as particles into the core.

The core can, on the one hand, be produced by a so-called Airlaid process or by a so-called Wetlaid process, whereby a core produced according to the Airlaid process is preferred. In the Wetlaid process, the particles of compacted superabsorber according to the invention are processed, together with further substrate fibers and a liquid, into a non-woven material. In the Airlaid process, the particles of compacted superabsorber according to the invention and the substrate fibers are processed in dry state to a non-woven material. Further details regarding Airlaid processes are described in U.S. Pat. No. 5,916,670, as well as U.S. Pat. No. 5,866,242 and relating to Wetlaid processes in U.S. Pat. No. 5,300,192, the disclosures of which are hereby incorporated herein in their entirety by this reference and form part of the disclosure.

In the Wetlaid and Airlaid processes, in addition to compacted superabsorber according to the invention and the substrate fibers, further suitable additives known to the skilled person can be used which contribute to the consolidation of the nonwoven materials obtained from this process.

In the embodiment in which the composite is a diaper, the components of a diaper, which are different from the compacted superabsorber according to the invention, represent the substrate of the composite. In a preferred embodiment, the diaper comprises a previously described core. In this case, the components of the diaper which are different from the core represent the substrate of the composite. In general, a composite used as a diaper comprises a water-impermeable under-layer, a water-permeable, preferably hydrophobic, upper-layer and a layer comprising a compacted superabsorber according to the invention, which is disposed between the under-layer and the upper-layer. This layer comprising a compacted superabsorber according to the invention is preferably an above-described core. The under-layer can comprise all materials known to the skilled person, whereby polyethylene or polypropylene are preferred. The upper-layer can likewise comprise all materials known to the skilled person and suitable, whereby polyesters, polyolefins, viscose, and the like are preferred, which result in a layer which is so porous that they assure a sufficient liquid-permeability of the upper-layer. In the context of the embodiment relating to the diaper, reference is made to the disclosure in U.S. Pat. No. 5,061,295, U.S. Pat. No. Re. 26,151; U.S. Pat. No. 3,592,194; U.S. Pat. No. 3,489,148, U.S. Pat. No. Re 32,649; U.S. Pat. No. 5,047,023; U.S. Pat. No. 4,834,735; EP 0254476 A1; EP 0325416 A1; U.S. Pat. No. 5,061,259; EP 0304319 A1; U.S. Pat. No. 5,147,343; EP 0339461; U.S. Pat. No. 5,149,335; EP 0443627 A1; EP 0765649 A2; U.S. Pat. No. 5,236,427; EP 0469591 A1; U.S. Pat. No. 5,244,735; U.S. Pat. No. 5,026,800; EP 0349240 A1; EP 0349241 A1; U.S. Pat. No. 5,300,054; EP 0565630 A1; U.S. Pat. No. 5,304,161; U.S. Pat. No. 5,439,458; EP 0565606 A1; U.S. Pat. No. 5,180,622; U.S. Pat. No. 5,149,334; EP 0591168 A1; U.S. Pat. No. 5,330,822; U.S. Pat. No. 5,384,179; U.S. Pat. No. 5,300,565; U.S. Pat. No. 5,397,626; U.S. Pat. No. 5,492,962; EP 0525049 A1; U.S. Pat. No. 5,354,290; U.S. Pat. No. 5,403,870; U.S. Pat. No. 5,415,643; EP 0601529; U.S. Pat. No. 5,419,956; U.S. Pat. No. 5,422,169; U.S. Pat. No. 5,505,718; EP 0579764 A1; U.S. Pat. No. 5,509,914; EP 0336578 A1; EP 1029522 A2; U.S. Pat. No. 5,509,915; EP 0532002 A1; EP 0539703 A1; EP 0761191 A2; EP 0761192 A2; U.S. Pat. No. 5,516,569; U.S. Pat. No. 5,562,646; U.S. Pat. No. 5,599,335; U.S. Pat. No. 5,669,894; WO 95/26209; EP 0752892 A1; U.S. Pat. No. 5,601,542; EP 0615736 A1; EP 0962206 A2; U.S. Pat. No. 5,744,564; WO 93/19099; WO 92/16565; EP 0516925 A1; U.S. Pat. No. 5,760,080; EP 0712659 A1; U.S. Pat. No. 5,797,893; EP 0761241 A3; U.S. Pat. No. 5,836,929; U.S. Pat. No. 5,762,641; EP 0631768 A1; EP 0640330 A1; U.S. Pat. No. 5,843,059; EP 0863733 A1; U.S. Pat. No. 5,865,822; EP 0937444 A3; EP 0937445 A3; U.S. Pat. No. 5,976,696; EP 0789048 A1; WO 97/43331; EP 0897409 A1; U.S. Pat. No. 6,068,620; WO 99/49826; U.S. Pat. No. 6,110,984; EP 0835885 A2; U.S. Pat. No. 6,121,509; WO 99/34842; EP 1045706; WO 99/34841; EP 1045707; WO 95/05856; EP 0715525 A1; WO 98/47454; EP 0975297 A1; WO 98/48857; EP 0981380 A1; WO 99/53877; EP 0951913 A1; EP 0845272 A1; EP 0872491 A1; EP 0882502 A1; EP 0940148 A1; U.S. Pat. No. 5,941,862; EP 0873101; WO 97/25013; as well as U.S. Pat. No. 3,860,003. These disclosures are hereby incorporated herein in their entirety by this reference and form thereby part of the disclosure.

The sealant materials are preferably water-absorbent films, wherein a compacted superabsorber according to the invention is worked into a polymer-matrix or fiber-matrix as substrate. This occurs preferably in that a compacted superabsorber according to the invention is mixed and then by means of optional thermal treatment connected with a polymer (Pm) which forms the polymer- or fiber-matrix. In the embodiment in which the composite is a cable, a compacted superabsorber according to the invention can be used directly as particles, preferably below the insulation of the cable. In another embodiment of the cable, a compacted superabsorber according to the invention can be used in the form of swellable, tension-resitant, yarns. According to another embodiment of the cable, a compacted superabsorber according to the invention can be used as a swellable film. In turn, in another embodiment of the cable, a compacted superabsorber according to the invention can be used as a moisture-absorbent core in the middle of the cable. The substrate forms, in the case of the cable, all components of the cable which do not comprise a compacted superabsorber according to the invention. Hereunder fall the conductors built into the cables, such as electrical conductors or light conductors, optical or respectively electrical insulation means as well as components of the cable which guarantee the mechanical demands made on the cable, such as networks, webs, or fabrics of materials that are guaranteeing tensile strength such as artificial materials and insulators out of rubber or other materials which hinder the destruction of the outer surface of the cable.

The invention further relates to a process for producing a composite, wherein a compacted superabsorber according to the invention and a substrate and optionally a suitable additive are brought in contact together. The bringing into contact occurs preferably by means of Wetlaid and Airlaid processes, compacting, extrusion, and mixing.

In addition, the invention relates to a composite which is obtainable by the above process.

The invention further relates to foams, formed bodies, fibers, sheets, films, cables, sealing materials, liquid-absorbing hygiene articles, carriers for plant and fungus growth-regulating agents, additives for building materials, packaging materials, and soil additives, which comprise a compacted superabsorber according to the invention or a previously described substrate.

The invention also relates to the use of a compacted superabsorber according to the invention or of an above-described substrate in foams, formed bodies, fibers, sheets, films, cables, sealant materials, liquid-absorbing hygiene articles, carriers for plant and fungus growth-regulating agents, additives for building materials, packaging materials, and soil additives.

The invention is more closely illustrated in the following by the examples.

### TEST METHODS

Centrifugation Retention Capacity (CRC)

CRC is given according to the teabag method and as an average of three measurements. About 200 mg of polymer are sealed in a teabag and immersed for about 30 minutes in about 0.9 % NaCl solution. The teabag is then spun in a centrifuge (about 23 cm diameter, about 1,400 rpm) for about 3 minutes and weighed. A teabag without water-absorbing polymer is run as a blind value.

Absorbency Against Pressure (AAP)

The absorbency against pressure (load about 0.7 psi) is determined according to a method described in EP 0 339 461, page 7. About 0.9 g superabsorber are weighed into a cylinder with a sieve bottom. The equally distributed superabsorber layer is loaded with a stamp, which exerts a pressure of about 0.7 psi. The previously weighed cylinder is then placed on a glass filter plate which is situated in a tray with about 0.9% NaCl solution, the liquid level of which corresponds exactly to the height of the filter plate. After the cylinder unit has been allowed to absorb about 0.9% NaCl solution for about 1 hour, this is re-weighed and the AAP calculated as follows:
AAP=final weight(cylinder unit+swollen superabsorber)−initial weight(cylinder unit+superabsorber)/initial weight superabsorber.

Stability Test

The stability test is carried out with a roll mill US Stoneware Jar Mill (US Stoneware Model 755). To this are added about 10 g compacted superabsorber into the grinding pot (Alumina fortified Grinding Jar; Stoneware 774, Size 000), together with about 127 g grinding means (cylindrical porcelain pieces; Stoneware about 0.5 inch O.D.*about 0.5 inches long).

The grinding jar is closed, laid on the roll mill, and ground for about 6 minutes at about 95 rpm. The particle spectrum of the compacted superabsorber is then measured. The smaller the fraction less than about 150 μm, the more stable are the compacts.

Swell Presure

This process serves for judging how quickly a swell body achieves its maximum swell state and which swell pressure forms in the test medium.

In this method are used a Stevens L.F.R.A. Texture Analyser, a measuring body with a height of about 3.5 cm and a diameter of about 2.5 cm, a measuring cylinder with a height of about 7.4 cm and an inner diameter of about 2.7 cm, a balance with about 0.01 g precision, a labjack, an XYT-writer, a measuring cylinder of about 10 ml, as well as an about 20 to about 50 mesh sieve, USA Standart ASTM, and as chemicals, distilled water with a pH-value of about 6-7, less than or equal to about 4 μs/cm, as well as purest NaCl of the company Merk with the Article Number 6400.

About 0.5 g product of the fraction about 20 to about 50 mesh are weighed into the measuring cylinder, and about 10 ml about 0.9 wt.-% aqueous NaCl solution is added. The cylinder was then raised using a labjack until it is beneath the operators lower edge and fixed. The measurement occurs with the settings speed of about 1.0 mm/s, Distance 00 and Hold. The swell pressure was read in grams from the XYT-writer.

### EXAMPLES

### Example 1

About 300 kg acrylic acid was mixed with about 429 kg H₂O; about 1.2 kg allyloxypotyethylene gycol acrylic acid ester and about 1.2 kg polyethylene glycol-300-diacrylate and cooled to about 10IC. Then a total of about 233 kg about 50% sodium hydroxide was added so slowly that the temperature did not exceed about 30° C. The solution was then purged at about 20° C. with nitrogen and thus further cooled. Upon reaching the start temperature of about 4° C., the initiator solutions (about 0.1 kg 2,2′-azobis-2-amidinopropane-dihydrochloride in about 10 kg H₂O; about 0.15 kg sodiumperoxydisulfate in about 10 kg H₂0; about 0.1 kg about 30% hydrogen peroxide solution in about 1 kg H₂O and about 0.01 kg ascorbic acid in about 2 kg H₂O) are added. The polymerisation was carried out on a continuous band with a dwell time of about 40 minutes. The gel formed was comminuted and dried at about 150° C. to about 180° C. for about 60 minutes. The dried polymer was coarsely chopped, ground, and continuously sieved to a powder with a particle size of about 150 μm to about 850 μm. The fines fraction had the following particle distribution:
Greater than about 200 μm about 8%
Greater than about 150 μm about 53%
Less than about 150 μm about 39%
CRC about 26 g/g

### Example 2

The about 150 to about 850 μm fraction from Example 1 was continuously coated with about 2% of a solution of about 1 part ethylene carbonate and about 1 part water in an intensive mixer and heated in a paddle dryer to about 185° C. (dwell time about 90 min.). The fines fraction generated by abrasion was sieved away.

Particle Distribution: Greater than about 200 μm about 4%
Greater than about 150 μm about 47%
Less than about 150 μm about 49%
CRC about 19 g/g
AAP 0.7 psi about 18.5 g/g

### Examples 3 to 11

The fines from Example 2 were compacted in a hydraulic press (Weber, PW20) using different binding agents at pressures from about 1.7·10³ N/cm² to about 33.7·10³ N/cm². The fines were mixed with the binding agent using a Krupps kitchen mixer, and about 7 g of the mixture was compacted in a round container (diameter about 27.5 mm) for about 15 seconds under the given pressure.

| | | Binding agent | | |
|---|---|---|---|---|
| | Pressure | [wt.- % based | Stability of | Tensile |
| Example | 10³ N/cm² | on Fines] | the tablets | strength N |
| 3 | 1.7 | No | No | — |
| 4 | 33.7 | No | Very low | — |
| 5 | 16.8 | Water [1] | Low | — |
| 6 | 16.8 | Water [5] | Good | — |
| 7 | 25.3 | Water [5] | Very good | 770 N |
| 8 | 16.8 | Estekoll | Good | — |
| | | 20/50¹⁾ [10] | | |
| 9 | 16.8 | Sarpifan HF | Good | — |
| | | 300¹⁾ [10] | | |
| 10 | 25.3 | Eudragit | Good | 191 N |
| | | NE30D²⁾ [5] | | |
| 11 | 25.3 | Water/ | Very good | 1105 N |
| | | aluminium | | |
| | | sulfate · 18 | | |
| | | H₂O(1:1) [6] | | |

¹⁾trade product of the company Stockhausen GmbH & Co. KG
²⁾trade product of the company Rohm GmbH

### Example 12

The fines from Example 2 were mixed in an Elrich intensive mixer, type R02, with about 5 wt.-% water, based on the weight of the fines. This product was then compacted on a Hosokawa-Bepex-laboratory compactor, type L 200/50.

| | |
|---|---|
| Specific contact force: | about 120 kN/cm |
| Temperature: | about 55-about 60° C. |
| Throughput: | about 25-about 30 kg/h |

The compacted superabsorber was then comminuted in a sieve granulator (Frewitt, type MG 633) with an about 0.8 mm sieve.

| | |
|---|---|
| Yield: | about 48% compacted superabsorber |
| | >150 μm |
| Particle distribution: | about 49% > about 150 μm |
| | about 32% > about 300 μm |
| | about 19% > about 600 μm |
| CRC: | about 18 g/g |
| AAP 0.7 psi: | about 16 g/g |

The products are stable, do not dust and do not disintegrate on swelling.

### Example 13

As described in Example 12, fines from Example 1 were compacted and then comminuted in the sieve granulator.

| | |
|---|---|
| Yield: | about 62% compacted superabsorber |
| | >150 μm |
| Particle distribution: | about 41% > about 150 μm |
| | about 33% > about 300 μm |
| | about 26% > about 600 μm |
| CRC: | about 25 g/g |

### Example 14 to 17

In a continuous experiment, fines were mixed with a binding agent in a Shuggi-mixer and compacted on a Bepex-roll compactor. The throughput amounted to about 400 to about 500 kg/h and the specific contact force about 40 kN/cm. Then the compacted superabsorber was comminuted on a roll mill and sieved to about 150 to about 850 μm.

| | | | | | Particle | | | Stability |
|---|---|---|---|---|---|---|---|---|
| | Fines | | | | distribution % | | | after ball |
| | from | Binding | CRC | AAP | >150 | >300 | >600 | mill |
| Example | Example | agent⁽¹⁾ | g/g | 0.7 psi | μm | | | >150 μm |
| 14 | 1 | A | 26 | 9 | 37 | 44 | 19 | 68% |
| 15 | 1 | B | 25 | 8 | 29 | 41 | 30 | 71% |
| 16 | 2 | A | 18 | 17 | 18 | 49 | 33 | 77% |
| 17 | 2 | B | 17 | 16 | 21 | 47 | 32 | 83% |
| comparison | 2 | none | 19 | 18 | | 0 | 0 | — |

(no compact)

⁽¹⁾Binding agent A: about 6.6% water
Binding Agent B: about 6% solution (water/aluminium sulfate · 18 H₂O 1:1)

### Example 18 and 19

On a M+J Airlaid installation were produced homogeneous Airlaids with the following composition:

| | | | |
|---|---|---|---|
| Fluff: | Stora, EF untreated | about 117 | g/m² |
| Bico-fibers: | Danaklon, AL-Thermal-C.Phil, | about 27 | g/m² |
| | about 6 mm-3.3 dtex | | |
| Tissue: | Finess | about 18 | g/m² |
| Compacted | | about 43 | g/m² |
| superabsorber: | | | |

The absorption cores with compacted superabsorbers were tested in comparison to FAVOR SX FAM (Stockhausen product).

An Airlaid with the dimensions about 19.5×about 7.5 cm and a weight of about 4.0 g is laid in a U-shaped carrier (diameter about 28 cm) and loaded with a weight of about 500 g. about 20 g test liquid¹⁾ are dosed by means of a pump into the middle of the sample within about 30 minutes. After a further about 60 minutes, the Airlaid is weighed and the absorption calculated from the difference of the weights of the damp and of the dry Airlaids.
¹⁾Composition for about 1000 g of the solution:

For determination of the Rewet, about 50 g filter papers are laid evenly over the test sample and loaded with about 500 g. After about 10 minutes the weight increase of the filter papers is measured and given as Rewet. The test sample is then spun for about 5 minutes in a centrifuge at about 1400 rpm. The Retention is given by the difference of weight of the centrifuged and of the dry Airlaid.

| | | |
|---|---|---|
| NaCl: | about 6.1 | g |
| NaHCO₃: | about 2.3 | g |
| CaCl₂: | about 0.3 | g |
| Albumin: | about 65. | g |
| CMC: | about 13. | g |
| Antispumin DNF (10 wt.-% solution): | about 4. | g |
| Cosmetic colourant: | about 4. | g |
| Water: | about 905.3 | g |

The salts, the Albumin, and the CMC are added in the above order to the fully deionised water, with stirring. After the components are fully dissolved, Antispumin DNF is added to minimize foam formation. The colourant is then added, and the pH-value adjusted using dil. hydrochloric acid or respectively dil. sodium hydroxide to a pH=7.4. The solution can be kept for a maximum of about 3 days with cooling (max. +10° C.).

| Superabsorber | | | |
|---|---|---|---|
| in the Airlaid | From Example 16 | From Example 17 | SXFAM |
| Absorption (g) | about 20.1 | about 19.9 | about 20.1 |
| Rewet (g) | about 3.3 | about 3.3 | about 8.9 |
| Retention (g) | about 15.2 | about 14.6 | about 14.1 |

1. A compacted superabsorber, comprising a composition at least comprising a synthetic particulate superabsorber an inorganic binding agent subjected to a specific contact force of at least about 3 kN/cm or a pressure of at least about 3 kN/cm², wherein more than about 5% of the particles used have a particle size of about 250 μm or less.

2. The compacted superabsorber according to claim 1, wherein the inorganic binding agent in the form of an aqueous solution is mixed with the superabsorber before the compacting.

3. The compacted superabsorber according to claim 1, wherein the inorganic binding agent is an inorganic salt of a polyvalent cation.

4. The compacted superabsorber according to claim 3, wherein the inorganic salt is used in the form of an aqueous solution, in which the inorganic salt comprises in a concentration of about 20 to about 70 wt. %.

5. The compacted superabsorber according to claim 3, wherein the inorganic binding agent comprises an aqueous solution of Al₂(SO₄)₃.18 H₂O.

6. The compacted superabsorber according to claim 1, wherein more than about 35% of the particles used have a particle size of about 150 μm or less.

7. The compacted superabsorber according to claim 1, wherein the composition has a water content of at least about 1 wt. %.

8. The compacted superabsorber according to claim 1, wherein the particulate superabsorber is a post-crosslinked superabsorber.

9. A process for producing compacted superabsorbers, the process comprising providing a composition at least comprising synthetic particulate superabsorber and an inorganic binding agent; and compacting the composition to a specific contact force of at least about 3 kN/cm or a pressure of at least about 3 kN/cm², wherein more than about 5% of the particles used have a particle size of about 250 μm or less.

10. The process according to claim 9, wherein the inorganic binding agent in the form of an aqueous solution is mixed with the superabsorber before the compacting.

11. The process according to claim 9, wherein the inorganic binding agent is an inorganic salt of a polyvalent cation.

12. The process according to claim 11, wherein the inorganic salt is used in the form of an aqueous solution, in which the inorganic salt is comprised in a concentration of about 20 to about 70 wt. %.

13. The process according to claim 11, wherein the inorganic binding agent comprises an aqueous solution of Al₂(SO₄)₃.18 H₂O.

14. The process according to claim 9, wherein more than about 35% of the particles used have a particle size of less than about 150 μm.

15. The process according to claim 9, wherein the particles before the compacting are mixed with at least about 1 wt. % water, based on the weight of the total particles used for compacting.

16. The process according to claim 9, wherein the particulate superabsorber is a post-crosslinked superabsorber.

17. A process for producing a composite, the process comprising contacting a compacted superabsorber according to of claim 1 with a substrate.

18. A composite produced by the process according to claim 17.

19. The compacted superabsorber according to claim 1 comprising at least one of a foam, a formed body, a fibre, a sheet, a film, a cable, a sealing material, a liquid-absorbing hygiene article, a carrier for a plant, a fungus growth-regulating agent, a packaging material, a soil additive, and a building material.

20. A use of a compacted superabsorber according to claim 1, the use comprising at least one of a foam, a formed body, a fibre, a sheet, a film, a cable, a sealing material, a liquid-absorbing hygene article, a carrier for a plant, a fungus growth-regulating agent, a packaging materials, a soil additive and building material.

21. The compacted superabsorber according to claim 2, wherein the inorganic binding agent is an inorganic salt of a polyvalent cation.

22. The compacted superabsorber according to claim 21, wherein the inorganic salt is used in the form of an aqueous solution, in which the inorganic salt is comprised in a concentration of about 20 to about 70 wt. %.

23. The compacted superabsorber according to claim 4, wherein the inorganic binding agent comprises an aqueous solution of Al₂(SO₄)₃.18 H₂O.

24. The compacted superabsorber according to claim 21, wherein the inorganic binding agent comprising an aqueous solution of Al₂(SO₄)₃.18 H₂O.

25. The compacted superabsorber according to claim 22, wherein the inorganic binding agent an aqueous solution of Al₂(SO₄)₃.18 H₂O.

26. The compacted superabsorber according to claim 2, wherein more than about 35% of the particles used have a particle size of about 150 μm or less.

27. The compacted superabsorber according to claim 3, wherein more than about 35% of the particles used have a particle size of about 150 μm or less.

28. The compacted superabsorber according to claim 4, wherein more than about 35% of the particles used have a particle size of about 150 μm or less.

29. The compacted superabsorber according to claim 5, wherein more than about 35% of the particles used have a particle size of about 150 μm or less.

30. The compacted superabsorber according to claim 3, wherein the composition has a water content of at least about 1 wt. %.

31. The compacted superabsorber according to claim 5, wherein the composition has a water content of at least about 1 wt. %.

32. The compacted superabsorber according to claim 6, wherein the composition has a water content of at least about 1 wt. %.

33. The compacted superabsorber according to claim 3, wherein the particulate superabsorber is a post-crosslinked superabsorber.

34. The compacted superabsorber according to claim 5, wherein the particulate superabsorber is a post-crosslinked superabsorber.

35. The compacted superabsorber according to claim 6, wherein the particulate superabsorber is a post-crosslinked superabsorber.

36. The compacted superabsorber according to claim 7, wherein the particulate superabsorber is a post-crosslinked superabsorber.

37. The process according to claim 10, wherein the inorganic binding agent is an inorganic salt of a polyvalent cation.

38. The process according to claim 37, wherein the inorganic salt is used in the form of an aqueous solution, in which the inorganic salt is comprised in a concentration of about 20 to about 70 wt. %.

39. The process according to claim 12, wherein the inorganic binding agent comprises an aqueous solution of Al₂(SO₄)₃.18 H₂O.

40. The process according to claim 11, wherein more than about 35% of the particles used have a particle size of less than about 150 μm.

41. The process according to claim 12, wherein more than about 35% of the particles used have a particle size of less than about 150 μm.

42. The process according to claim 13, wherein more than about 35% of the particles used have a particle size of less than about 150 μm.

43. The process according to claim 11, wherein the particles before the compacting are mixed with at least about 1 wt. % water, based on the weight of the total particles used for compacting.

44. The process according to claim 12, wherein the particles before the compacting are mixed with at least about 1 wt. % water, based on the weight of the total particles used for compacting.

45. The process according to claim 13, wherein the particles before the compacting are mixed with at least about 1 wt. % water, based on the weight of the total particles used for compacting.

46. The process according to claim 14, wherein the particles before the compacting are mixed with at least about 1 wt. % water, based on the weight of the total particles used for compacting.

47. The process according to claim 12, wherein the particulate superabsorber is a post-crosslinked superabsorber.

48. The process according to claim 14, wherein the particulate superabsorber is a post-crosslinked superabsorber.

49. The process according to claim 15, wherein the particulate superabsorber is a post-crosslinked superabsorber.

50. A process for producing a composite, the process comprising contacting a compacted superabsorber according to claims 2 with a substrate.

51. A composite produced by the process according to claim 50.

52. A process for producing a composite, the process comprising contacting a compacted superabsorber according to claims 3 with a substrate.

53. A composite produced by the process according to claim 52.

54. A process for producing a composite, the process comprising contacting a compacted superabsorber according to claims 4 with a substrate.

55. A composite produced by the process according to claim 54.

56. A process for producing a composite, the process comprising contacting a compacted superabsorber according to claims 5 with a substrate.

57. A composite produced by the process according to claim 56.

58. A process for producing a composite, the process comprising contacting a compacted superabsorber according to claims 6 with a substrate.

59. A composite produced by the process according to claim 58.

60. A process for producing a composite, the process comprising contacting a compacted superabsorber according to claims 7 with a substrate.

61. A composite produced by the process according to claim 60.

62. A process for producing a composite, the process comprising contacting a compacted superabsorber according to claims 8 with a substrate.

63. A composite produced by the process according to claim 62.

64. The compacted superabsorber according to claim 2 comprising at least one of a foam, a formed body, a fibre, a sheet, a film, a cable, a sealing material, a liquid-absorbing hygiene article, a carrier for a plant, a fungus growth-regulating agent, a packaging materials, a soil additives and building material.

65. The compacted superabsorber according to claim 3 comprising at least one of a foam, a formed body, a fibre, a sheet, a film, a cable, a sealing material, a liquid-absorbing hygiene article, a carrier for a plant, a fungus growth-regulating agent, a packaging materials, a soil additives and building material.

66. The compacted superabsorber according to claim 4 comprising at least one of a foam, a formed body, a fibre, a sheet, a film, a cable, a sealing material, a liquid-absorbing hygiene article, a carrier for a plant, a fungus growth-regulating agent, a packaging materials, a soil additives and building material.

67. The compacted superabsorber according to claim 5 comprising at least one of a foam, a formed body, a fibre, a sheet, a film, a cable, a sealing material, a liquid-absorbing hygiene article, a carrier for a plant, a fungus growth-regulating agent, a packaging materials, a soil additives and building material.

68. The compacted superabsorber according to claim 6 comprising at least one of a foam, a formed body, a fibre, a sheet, a film, a cable, a sealing material, a liquid-absorbing hygiene article, a carrier for a plant, a fungus growth-regulating agent, a packaging materials, a soil additives and building material.

69. The compacted superabsorber according to claim 7 comprising at least one of a foam, a formed body, a fibre, a sheet, a film, a cable, a sealing material, a liquid-absorbing hygiene article, a carrier for a plant, a fungus growth-regulating agent, a packaging materials, a soil additives and building material.

70. The compacted superabsorber according to claim 8 comprising at least one of a foam, a formed body, a fibre, a sheet, a film, a cable, a sealing material, a liquid-absorbing hygiene article, a carrier for a plant, a fungus growth-regulating agent, a packaging materials, a soil additives and building material.

71. A use of a composite according to claim 17, the use comprising at least one of a foam, a formed body, a fibre, a sheet, a film, a cable, a sealing material, a liquid-absorbing hygiene article, a carrier for a plant, a fungus growth-regulating agent, a packaging materials, a soil additive and building material.
